(19) United States
(12) Patent Application Publication
(10) Pub. No.: US 2026/0347565 A1
(43) Pub. Date: Nov. 5, 2026

(54) FLUOROELASTOMER COMPOUNDS

(71) Applicants: DUPONT SPECIALTY PRODUCTS USA, LLC, Wilmington, DE (US); DUPONT SPECIALTY PRODUCTS OPERATIONS SARL, Meyrin (CH)

(72) Inventors: Christopher BISH, Wilmington, DE (US); Jean-Luc MATOUX, Meyrin (CH)

(21) Appl. No.: 19/108,491

(22) PCT Filed: Nov. 20, 2023
(86) PCT No.: PCT/US2023/080464

§ 371 Date: Mar. 4, 2025

Related U.S. Application Data
(60) Provisional application No. 63/384,684, filed on Nov. 22, 2022.

(51) Int. Cl. C08K 3/04; C08K 5/315

(52) U.S. Cl. CPC C08K 3/04; C08K 5/3155; C08K 2201/006

(57) ABSTRACT

This invention relates to fluoroelastomer compounds comprising specific types of carbon black, and articles cured from the compounds. The specific types of carbon black improve both tensile strength and elongation at break, when added in fluoroelastomer compounds.

### CROSS-REFERENCE TO RELATED APPLICATION

This application claims the benefit of U.S. Provisional Application No. 63/384,684, filed on Nov. 22, 2022, the disclosure of which is hereby expressly incorporated herein by reference in its entirety.

### TECHNICAL FIELD

This invention relates to fluoroelastomer compounds comprising specific types of carbon black and curing agent, and articles cured from the compounds.

### BACKGROUND

Elastomer compounds that comprise a fluoroelastomer have achieved outstanding commercial success because they can be used in severe environments, in particular, during exposure to high temperatures and to aggressive chemicals. For example, these compounds are used in seals in hot sections of aircraft engines, in oil-well drilling devices, and as sealing elements in industrial equipment that operate at high temperatures.

The properties of cured elastomer compounds arise largely because of the stability and inertness of the copolymerized monomers that make up the major portion of the polymeric backbone of these compounds. Such monomers include tetrafluoroethylene and perfluoro(alkyl vinyl) ethers. In order to develop elastomeric properties fully, elastomer compounds are typically crosslinked, i.e., vulcanized or cured. To this end, a small percentage of cure site monomer is copolymerized with the monomers (whether fluorinated or perfluorinated). Upon crosslinking, the cure site monomer reacts with a curing agent to form a crosslinked elastomer entity in the form of an article.

Cure site monomers containing at least one nitrile group, for example perfluoro-8-cyano-5-methyl-3,6-dioxa-1-octene, may be used and compositions comprising such cure site monomers are described in U.S. Pat. No. 7,999,049, col. 10 through col 16.

Fluoroelastomer compounds containing amidines are disclosed in U.S. Pat. No. 10,472,494, which is hereby incorporated herein by reference in its entirety.

Mechanical properties of cured elastomer compounds are normally adjusted by incorporating many kinds of additives. Tensile strength and elongation at break are both highly required properties as cured elastomer compounds, but it is difficult to obtain both high tensile strength combined with high elongation at break.

### BRIEF SUMMARY

Specific types of carbon black improve both tensile strength and elongation at break, when added in fluoroelastomer compounds.

The invention is directed to a compound comprising:
(A) a fluoroelastomer comprising copolymerized units of:
(1) one or more unsaturated fluorinated olefins;
(2) one or more unsaturated fluorinated olefin co-monomer different from (1), and selected from the group consisting of fluorovinyl ethers, unsaturated fluorinated olefins, unsaturated olefins, and mixtures of these; and
(3) one or more cure site monomers selected from the group consisting of nitrile-containing fluorinated olefins and nitrile-containing fluorinated vinyl ethers;
(B) at least one curing agent; and
(C) one or more carbon black, at least one of the carbon black has between 20 and 40 m²/g of statistical thickness surface area.

The invention further directed to an article, comprising a cured compound that, before curing, comprised:
(A) a fluoroelastomer comprising copolymerized units of:
(1) one or more unsaturated fluorinated olefins,
(2) one or more unsaturated fluorinated olefin co-monomer different from (1), and selected from the group consisting of fluorovinyl ethers, unsaturated fluorinated olefins, unsaturated olefins, and mixtures of these; and
(3) one or more cure site monomer selected from the group consisting of nitrile-containing fluorinated olefins and nitrile-containing fluorinated vinyl ethers;
(B) at least one curing agent, and
(C) one or more carbon black, at least one of the carbon black has between 20 and 40 m²/g of statistical thickness surface area.

### DETAILED DESCRIPTION

### Abbreviations

The claims and description herein are to be interpreted using the abbreviations and definitions set forth below.
“h”, “hrs” refers to hours.
“%” refers to the term percent.
“mole %” refers to mole percent.
“wt %” refers to weight percent.
“°C” refers to degree Celsius.
“parts” refers to parts by weight.
“phr” refers to parts per hundred parts of fluoroelastomer (rubber); one of skill in the art uses and recognizes this term of measurement. For example, 3 parts of a component per 100 parts fluoroelastomer is written as 3 phr. In these compounds, processes, and articles described herein, phr is based on 100 parts of fluoroelastomer.
“g” refers to grams
“Ph” refers to a phenyl ring.

### DEFINITIONS

As used herein, the article “a” refers to one as well as more than one and does not necessarily limit its referent noun to the grammatical category of singular number.

As used herein, the terms “about” and “at or about”, when used to modify an amount or value, refers to an approximation of an amount or value that is more or less than the precise amount or value recited in the claims or described herein. The precise value of the approximation is determined by what one of skill in the art would recognize as an appropriate approximation to the precise value. As used herein, the term conveys that similar values, not precisely recited in the claims or described herein, can bring about results or effects that are equivalent to those recited in the claims or described herein, for which one of skill in the art would acknowledge as acceptably brought about by the similar values.

As used herein, the term “article” refers to an unfinished or finished item, thing, object, or an element or feature of an unfinished or finished item, thing or object. As used herein, when an article is unfinished, the term “article” may refer to any item, thing, object, element, device, etc. that has a form, shape, configuration that may undergo further processing in order to become a finished article. When an article is unfinished, the term “preform” may refer to that form, shape, configuration, any part of which may undergo further processing to become finished. As used herein, when an article is finished, the term “article” refers to an item, thing, object, element, device, etc. that is in a form, shape, configuration that is suitable for a particular use/purpose without further processing of the entire entity or a portion of it.

An article may comprise one or more element(s) or subassembly(ies) that either are partially finished and awaiting further processing or assembly with other elements/subassemblies that together will comprise a finished article. In addition, as used herein, the term “article” may refer to a system or configuration of articles.

As used herein, the terms “comprises,” “comprising,” “includes,” “including,” “has,” “having” or any other variation of these, refer to a non-exclusive inclusion. For example, a process, method, article, or apparatus that comprises a list of elements is not limited to only the listed elements but may include other elements not expressly listed or inherent. Further, unless expressly stated to the contrary, “or” refers to an inclusive, not an exclusive, or. For example, a condition A or B is satisfied by any one of the following: A is true (or present) and B is false (or not present), A is false (or not present) and B is true (or present), and both A and B are true (or present). As used herein, the terms “comprises,” “comprising,” “includes,” “including,” “has,” “having”, “consisting essentially of”, and “consisting of” or any other variation of these, may refer either to a non-exclusive inclusion or to an exclusive inclusion.

When these terms refer to a more exclusive inclusion, these terms limit the scope of a claim to those recited materials or steps that materially affect the novel elements of the recited invention.

When these terms refer to a wholly exclusive inclusion, these terms exclude any element, step or component not expressly recited in the claim. As used herein, terms that describe molecules or polymers follow the terminology in the IUPAC Compendium of Chemical Terminology version 2.15 (International Union of Pure and Applied Chemistry) of Sep. 7, 2009.

As used herein, the term “unsaturated fluorinated olefin” refers to linear, branched, or cyclic hydrocarbon structures which comprise at least one unsaturated double bond and comprise at least one fluorine atom.

As used herein, the term “alkyl” refers to linear, branched, or cyclic hydrocarbon structures and combinations of there. Alkyl does not include aromatic structures. Examples of linear alkyl groups include methyl, ethyl, propyl, butyl, pentyl, and hexyl groups. Branched alkyl groups include for example s- and t-butyl, and isopropyl groups. Examples of cyclic hydrocarbon groups include cyclopropyl, cyclopentyl, cyclohexyl, cyclobutyl, and cyclooctyl groups.

As used herein, the term “alkoxy” or “alkoxyl” refers to alkyl groups attached to an oxygen atom by a single bond. The other bond of the oxygen atom is connected to a carbon atom. Examples include methoxy, ethoxy, propoxy, isopropoxy, cyclopropyloxy, and cyclohexyloxy.

As used herein, the term “compound” refers to a composition that is able to be cured, i.e., a curable composition, as well as to a mixture of chemical entities that comprises at least a fluoroelastomer and a curing agent. The mixture of chemical entities has not been cured nor has undergone processing conditions that would cause the curing of the mixture of chemical entities to undergo curing.

As used herein, the prefix term “fluoro”, when placed as a prefix before a chemical entity name, refers to a chemical entity that has at least one fluorine atom as exemplified by the following designations: fluoroelastomers, perfluoroelastomers, fluorovinyl, and perfluorovinyl ethers. The prefix “fluoro”, when placed as a prefix before a chemical entity name, expressly includes “perfluoro” chemical entities. Thus, the prefix “fluoro”, when preceding a chemical entity name, indicates both “fluoro-” entities and “perfluoro-” entities.

As used herein, the term “cured” refers to that resultant entity that comprised a fluoroelastomer and which has been exposed to those conditions that caused the fluoroelastomer molecules to form sufficient crosslinks among themselves (that is, curing conditions) such that the resultant entity takes on a form or shape or configuration or structure that cannot be reprocessed, molded, or extruded into a different one. That is, once a resultant entity which comprised a fluoroelastomer has been exposed to curing conditions to thereby be cured, that entity cannot be re-cured to take on a substantially different form or shape or configuration or structure.

As used herein, the terms “curing”, “cured” refer to that processing of a compound, also called herein curable composition, which results in an entity taking on a form or shape or configuration or structure that cannot be reprocessed, molded, or extruded into a different one. Such processing refers to the “curing process/processing”, which requires compounds to be exposed to certain conditions in order to initiate the curing process, such conditions called curing conditions.

The resultant entity of the curing process is a “cured” entity, that is, an article as defined hereinabove. To be clear, curing results in compounds taking on a form or shape or configuration or structure of an article. Cured articles of compounds described herein include, but are not limited to, O-rings, seals, and gaskets.

The terms “curing”, “cured” also expressly include differing degrees of processing of a compound such that the resultant entity takes on a form or shape or configuration or structure that cannot be reprocessed, molded, or extruded into a different one and which may exhibit certain physical properties as a result of the curing.

To the point, these compounds may be initially cured to achieve a non-reprocessable form, shape, etc., which has been termed “cured” herein. The cured compounds may be further subjected to additional curing conditions, which provide additional, subsequent curing. Such additional curing conditions may be variously termed herein either as “curing” or as “post-curing”. That is, the terms “curing”, “cured” refer to both an initial curing process that results in a first cured, resultant entity and also expressly refer to any subsequent curing process that results in a subsequently cured, resultant entity that may or not possess different material or physical properties than those of the first cured, resultant entity.

### Ranges and Preferred Variants

Any range set forth herein expressly includes its endpoints unless explicitly stated otherwise. Setting forth an amount, concentration, or other value or parameter as a range specifically discloses all possible ranges formed from any possible upper range limit and any possible lower range limit, regardless of whether such pairs of upper and lower range limits are expressly disclosed herein. Compounds, processes and articles described herein are not limited to specific values disclosed in defining a range in the description.

The disclosure herein of any variation in terms of materials, chemical entities, methods, steps, values, and/or ranges, etc.—whether identified as preferred or not—of the processes, compounds and articles described herein specifically intends to include any possible combination of materials, methods, steps, values, ranges, etc. For the purpose of providing photographic and sufficient support for the claims, any disclosed combination is a preferred variant of the processes, compounds, and articles described herein.

### Compounds

### A) Fluoroelastomers

Fluoroelastomers described herein may be fluorinated or perfluorinated and comprise at least the following three copolymerized monomer units: (1) one or more unsaturated fluorinated olefins; (2) one or more unsaturated fluorinated olefin co-monomers different than unsaturated fluorinated olefin (1) and are selected from the group consisting of fluorovinyl ethers, unsaturated fluorinated olefins, unsaturated olefins, and mixtures of there; and (3) one or more cure site monomers selected from the group consisting of nitrile-containing fluorinated olefins, nitrile-containing fluorinated vinyl ethers, or a mixture of these, wherein the mole percent of each of (1), (2), and (3) is based on the total mole percent of (1), (2), and (3) in fluoroelastomer.

Alternatively, fluoroelastomers may be fluorinated or perfluorinated and comprise at least the following three copolymerized monomer units: (1) about 25 to 74.9 mole percent of one or more unsaturated fluorinated olefins; (2) about 25 to 74.9 mole percent of one or more unsaturated fluorinated olefin co-monomers different than unsaturated fluorinated olefin (1) and are selected from the group consisting of fluorovinyl ethers, unsaturated fluorinated olefins, unsaturated olefins, and mixtures of at least two of fluorovinyl ethers, unsaturated fluorinated olefins and unsaturated olefins; and (3) about 0.1 to 10 mole percent of one or more cure site monomers selected from the group consisting of nitrile-containing fluorinated olefins, nitrile-containing fluorinated vinyl ethers, or a mixture of these, wherein the mole percent of each of (1), (2), and (3) is based on the total mole percent of (1), (2), and (3) in fluoroelastomer.

Fluoroelastomers described herein may contain any of a variety of end groups as a result of the use of varying initiators or chain transfer agents during polymerization. Non-limiting examples of end groups include sulfonate, sulfonic acid, carboxylate, carboxylic acid, carboxamide, difluoromethyl groups, trifluorovinyl groups, or perfluorinated alkyl groups.

### (1) Unsaturated Fluorinated Olefins

Unsaturated fluorinated olefins (1) include unsaturated monomers comprising at least one fluorine atom, alternatively at least two fluorine atoms, and alternatively perfluorinated monomers. Examples of unsaturated fluorinated olefins include tetrafluoroethylene (C₂F₄), hexafluoropropylene, 1,1-difluoroethylene; 1,1,2-trifluoroethylene; 1-fluoroethylene, and combinations of these. The concentration of unsaturated fluorinated olefin (1) may range from 25 and 74.9 mole percent of the total moles of monomer units in fluoroelastomer.

### (2) Unsaturated Fluorinated Olefin Co-Monomers

Unsaturated fluorinated olefin co-monomer (2), which is different than unsaturated fluorinated olefin (1), is selected from the group consisting of fluorovinyl ethers, unsaturated fluorinated olefins, unsaturated olefins, and mixtures of these.

Examples of fluorovinyl ethers used to prepare fluoroelastomer include, perfluoro(alkyl vinyl) ethers (PAVE), perfluoro(alkoxy vinyl) ethers, fluoro(alkyl vinyl) ethers, fluoro(alkoxy vinyl) ethers, and mixtures of these. Suitable perfluorinated(alkyl vinyl) ethers which may be used to prepare the compounds described herein include those shown in formulas (II) to (VI):

CF₂═CFO(R_{f′}O)ₙ(R_{f″}O)ₘR_{f} (II)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

Additional examples of perfluoro(alkyl vinyl) ethers includes compositions of formula (III):

CF₂═CFO(CF₂CFXO)ₙR_{f} (III),

where X is F or CF₃, n is 0-5, and R_{f} is a perfluoroalkyl group of 1-6 carbon atoms. Alternatively, n is 0 or 1 and R_{f} contains 1-3 carbon atoms. Examples of such perfluorinated (alkyl vinyl) ethers include perfluoro(methyl vinyl) ether and perfluoro(propyl vinyl) ether.

Other perfluoro(alkyl vinyl) ether monomers for the preparation of fluoroelastomer include monomers of formulas (IV), (V), and (VI):

CF₂═CFO[(CF₂)ₘCF₂CFZO]ₙR_{f} (IV),
where R_{f} is a perfluoroalkyl group having 1-6 carbon atoms, m=0 or 1, n=0-5, and Z═F or CF₃;

CF₂═CFO[(CF₂CFCF₃O)ₙ(CF₂CF₂CF₂O)ₘ(CF₂)ₚ]CₓF₂ₓ₊₁ (V),
where m and n=1-10, p=0-3, and x=1-5. Specific embodiments of this class include monomers where n=0-1, m=0-1, and x=1 and

CF₂═CFOCF₂CF(CF₃)O(CF₂O)ₘCₙF₂ₙ₊₁ (VI),
where n=1-5, m=1-3, and where, alternatively, n=1.

Examples of perfluoro(alkyl vinyl) ethers include perfluoro methyl vinyl ether, perfluoropropyl vinyl ether, and perfluoroethyl vinyl ether. Examples of perfluoro(alkoxy vinyl) ethers include perfluoromethoxy vinyl ether, perfluoropropoxy vinyl ether, and perfluoroethoxy vinyl ether.

Examples of unsaturated fluorinated olefins include tetrafluoroethylene (C₂F₄); hexafluoropropylene; 1,1-difluoroethylene; 1,1,2-trifluoroethylene; 1-fluoroethylene; 1-fluoropropylene; 1,1-difluoropropylene; 1,1,3-trifluoropropylene; 1,1,3,3,3-pentafluoropropylene; and combinations of these. Examples of unsaturated olefins include ethylene, propylene, 1-butene, 2-butene, and combinations of these. Mixtures of fluorovinyl ethers, unsaturated fluorinated olefins, and unsaturated olefins may also be used.

The concentration of unsaturated fluorinated olefin co-monomer in fluoroelastomer ranges from 25 to 74.9 mole percent, alternatively from 30 to 65 mole percent, alternatively from 45 to 55 mole percent, based on the total mole percent of monomer units in fluoroelastomer.

### (3) Cure Site Monomers

Fluoroelastomer (A) further comprises copolymerized units of one or more cure site monomers comprising at least one nitrile substituent group. Alternatively, the cure site monomers are selected from the group consisting of nitrile-containing fluorinated olefins and nitrile-containing fluorinated vinyl ethers (3). The amount of such cure site monomers is, generally, from 0.1 to 10 mole percent, alternatively between 0.3 and 1.5 mole percent, based on the total mole percent of polymerizable monomer units used to prepare fluoroelastomer. Although more than one type of cure site monomer may be present, cure site monomers comprise at least one nitrile substituent group. Useful nitrile-containing cure site monomers include those of formulae (VII)-(XI):

CF₂═CF—O(CF₂)ₙ—CN (VII)
where n=2-12, alternatively 2-6;

CF₂═CF—O[CF₂—CFCF₃—O]ₓ—CF₂—CFCF₃—CN (VIII),
where n=0-4, alternatively 0-2;

CF₂═CF—[OCF₂CFCF₃]ₓ—O—(CF₂)ₙ—CN (IX),
where x=1-2, and n=1-4; and

CF₂═CF—O—(CF₂)ₙ—O—CF(CF₃)CN (X),
where n=2-4.

Monomers of formula (IX) are used as cure site monomers. Especially, cure site monomers include perfluorinated polyethers having a nitrile group and a trifluorovinyl ether group. Alternatively, cure site monomer is perfluoro(8-cyano-5-methyl-3,6-dioxa-1-octene) (8-CNVE) and represented by formula (XI):

CF₂═CFOCF₂CF(CF₃)OCF₂CF₂CN (XI)

### B) Curing Agents

The compound comprises at least one curing agent (B). Any curing agent can be used as long as the curing agent can react with the cure site described above.

One suitable curing agent (B) is a compound that decomposes at temperatures between 40 °C and 330 °C, alternatively between 90 °C to 220 °C, to produce ammonia. It is also called as ammonia generating compound. Examples of such ammonia generating compounds include, dicyandiamide, aldehyde ammonia condensation products, including acetaldehyde ammonia; and other compounds, such as hexamethylenetetramine; carbamates, for example t-butyl carbamate, benzyl carbamate, and HCF₂CF₂CH(CH₃)OCONH₂; urea; urea hydrochloride; thiourea; amides, such as phthalamide; metal ammine complexes, such as tetraamine copper (II) sulfate hydrate; ammonia-Lewis acid adducts; carboxamides, such as oxamic acid; biuret; unsubstituted amidines, such as formamidine, formamidine hydrochloride, and formamidine acetate.

Another suitable curing agent (B) is a compound which generate nitrogen-containing heterocycle cross links. Examples of such compound include, triazines, benzimidazoles, benzoxazoles, triazoles, amidines and hydrazides.

Other examples of the types of curing agents (B) that may be used in the compounds described herein include organotin curing agents or amino group-containing benzene curing agents. Nonlimiting examples of organotin curing agents include but are not limited to allyl-, propargyl-triphenyl- and allenyl tin curing agents. Specific examples of organotin curing agents include tetraalkyltin, tetraaryltin, and tetraphenyltin curing agents.

Examples of amino group-containing benzene curing agents include bis(aminophenols) and bis(aminothiophenols) of formulas (XII) and (XIII)

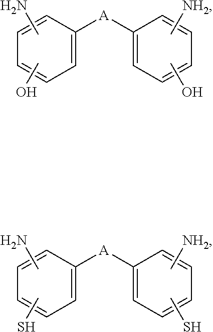

and tetraamines of formula (XIV)

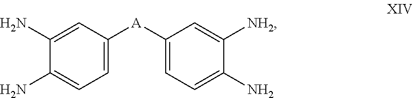

where A is SO₂, O, CO, alkyl of 1-6 carbon atoms, perfluoroalkyl of 1-10 carbon atoms, or a carbon-carbon bond linking the two aromatic rings. The amino and hydroxyl groups in formulas XII and XIII above, are interchangeable in the meta and para positions with respect to the group A. Specific examples of bis(aminophenol) and bis(aminothiophenol) curing agents include 2,2-bis[3-amino-4-hydroxyphenyl]hexafluoropropane (diaminobisphenol AF); 4,4′-sulfonylbis(2-aminophenol); 3,3′-diaminobenzidine; and 3,3′,4,4′-tetraaminobenzophenone, with 3,3′-diaminobenzidine being preferred.

The amount of curing agent employed will necessarily depend on the degree of crosslinking desired in the final product as well as the type and concentration of reactive moieties in the compounds described herein. One example of the level of the curing agent should be about 0.1 to 7 parts compound per 100 parts perfluoroelastomer, preferably about 1 to 5 parts compound per 100 parts perfluoroelastomer.

### C) Carbon Blacks

The compound of the invention comprises one or more carbon blacks (C). The carbon blacks of the invention has between 20 and 40 m²/g of statistical thickness surface area (STSA) measured by ASTM D6556-07. STSA is the external surface area which is accessible to rubber, while the total surface measurement (NSA measurement) is the total surface area which includes micropores. STSA of the carbon blacks used in the invented formulation is, alternatively between 25 and 35 m²/g.

In addition to STSA, the iodine adsorption is above 60 g/kg and ideally above 145 g/kg. Iodide absorption can be measured according to ASTM D1510.

Furthermore, the carbon blacks of the invention have a DBP Absorption above 50 cm³/100 g and alternatively 74 cm³/100 g of nitrogen surface area. Nitrogen surface area can be measured according to ASTM D2414B.

Furthermore, the pH of the carbon blacks is above 7 and alternatively above 9.

pH can be measured according to ASTM D1512.

This type of carbon blacks have non-detectable PAH (Poly Aromatic Hydrocarbons), with a detection limit of 5 ppb The carbon black of the invention can be amorphous.

Inventors of this invention found that: when using such specific carbon blacks in fluoroelastomer compounds, tensile strength is increased without decreasing elongation at break.

Examples of the carbon blacks which have the properties disclosed above are, Carbon Neat 90 available from CarbonNeat.

The concentration of carbon blacks (C) in the compounds ranges from 1 to 100 phr, alternatively from 5 to 100 phr.

Two or more carbon blacks can be used. When two or more carbon blacks are used, at least one carbon black need to be the above mentioned carbon blacks.

### Other Ingredients

The compounds described herein may additionally comprise a non-perfluoro-containing elastomer capable of independently cross-linking with any fluoroelastomer (A) cure sites. Examples of the non-perfluoro-containing elastomer are those having, at least at either its main chain or an end of its side chain, at least one kind of crosslinkable group selected from the group consisting of: cyano (—CN), carboxyl (—COOH), alkoxycarbonyl (—COOR₉, where R₉ is a monovalent organic group), and an acid halide group (—COX₁, where X₁ is a halogen atom) capable of a crosslinking reaction with fluoroelastomer (A).

Examples of non-perfluoro-containing elastomers include, but are not limited to, a fluorine-containing, but not a perfluoro-containing, rubber; a thermoplastic fluorine-containing rubber; and a rubber composition comprising a fluorine-containing rubber.

The fluorine-containing rubber may contain a monomer unit independently selected from the group consisting of vinylidene fluoride (VDF), tetrafluoroethylene, and hexafluoropropylene, and at least one additional monomer such as tetrafluoroethylene, hexafluoropropylene, perfluoro(alkyl vinyl ether), chlorotrifluoroethylene, trifluoroethylene, trifluoropropylene, pentafluoropropylene, trifluorobutene, tetrafluoroisobutene, vinyl fluoride, and iodine-containing fluorinated vinyl ethers, ethylene, propylene, alkyl vinyl ether, and combinations of these.

Additives such as stabilizers, plasticizers, lubricants, fillers, and processing aids typically utilized in compounding can be incorporated into the compounds described herein, provided they have adequate stability for the intended service conditions. In particular, low temperature performance can be enhanced by incorporation of perfluoropolyethers.

In addition to, or in combination with carbon blacks, non-carbon black fillers may be present in the compounds described herein. An example of a non-carbon black filler that may be used includes anhydrous silica such as acidic silica or fumed silica. Such silicas are available from Degussa Aktiengesellschaft (Frankfurt, Germany) under the Aerosil® trademark. A particularly useful type is Aerosil® 200 silica. Other suitable silicas include Reolosil® silicas, available from Tokuyama KK (Tokyo, Japan), for example Reolosil® QS13, Reolosil® QS102, and Reolosil® QS30. Silica amounts range from 1 to 25 phr, alternatively, no more than 1 to 7 phr.

Additional types of fillers include micropowders or fluoroadditives. Micropowders are ordinarily partially crystalline polymers. Micropowders include finely divided, easily dispersed plastic fluoropolymers that are solid at the highest temperature utilized in fabrication and curing of the compounds described herein. The term “solid” refers to a plastic fluoropolymer that has a crystalline melting temperature above the processing temperature(s) of the compounds described herein.

Micropowders that can be used in these compounds include, but are not limited to, micropowders based on the group of polymers known as tetrafluoroethylene (TFE) polymers. This group includes polytetrafluoroethylene (PTFE) and copolymers of TFE with small concentrations of about 1 mole percent or less of at least one copolymerizable modifying monomer such that the micropowders do not melt or soften during processing of fluoroelastomer A that comprise the micropowders. The modifying monomer may be, for example, hexafluoropropylene (HFP), perfluoro(propyl vinyl) ether (PPVE), perfluorobutyl ethylene, chlorotrifluoroethylene, or another monomer that introduces side groups into the polymer molecule.

Tetrafluoroethylene polymers used as additives in these compounds include copolymers of TFE having sufficient concentrations of copolymerized units of one or more monomers to reduce the melting point below that of PTFE. Such copolymers generally have melt viscosity in the range of 0.5-60×10³ Pa·s, but viscosities outside this range are also known. Perfluoroolefins and perfluoro(alkyl vinyl) ethers are preferred comonomers. Hexafluoropropylene and perfluoro(propyl vinyl) ether are most preferred. Examples of TFE copolymers include TFE/hexafluoropropylene copolymer and TFE/perfluoro(propyl vinyl)ether copolymers, provided they satisfy constraints on melting temperature with respect to perfluoroelastomer processing temperature. These copolymers can be utilized in powder form as isolated from the polymerization medium, if particle size is acceptable, or they can be ground to suitable particle size starting with stock of larger dimensions.

The amount of non-carbon black filler in these compounds ranges from about 0.01 to 33 phr and alternatively at least about 1 to 5 phr.

### Process for Preparing the Compounds and Curing Articles

The compounds described herein may be prepared by mixing until homogeneous fluoroelastomer (A), curing agent(s) (B), carbon black (C), and optional components using rubber compounding procedures such as a two roll rubber mill, an internal mixer, for example, a Banbury internal mixer, or in an extruder. These compounds may be cured by the application of heat and/or of pressure sufficient to cause curing agent (B) to form crosslinks with cure site monomer(s) or a dual cure system may also be used. When compression molding is used to cure, a press cure cycle is followed by a post cure cycle during which the press cured compound is heated at elevated temperatures in excess of 300 °C for several hours.

When cured, the compounds described herein become articles described herein and exhibit suitable thermal stability and chemical resistance for the applications in which these articles are used. Especially, the articles cured from the compounds shows both high tensile strength combined with high elongation at break. These articles are useful: as seals and gaskets for high temperature contexts, in a wide range of chemical environments, in seals for high temperature automotive uses, and O-rings.

### EXAMPLES

### Materials

Fluoroelastomer (FE): comprises 48.8 wt. % units of tetrafluoroethylene (TFE), 49.0 wt. % units of perfluoro(methyl vinyl) ether (PMVE) and 2.2 wt. % units of perfluoro(8-cyano-5-methyl-3,6-dioxa-1-octene) (8-CNVE). Fluoroelastomer can be prepared by the process disclosed in U.S. Pat. No. 5,789,489, col. 10 to 11.

Perfluoro(methyl vinyl) ether: available from Chemours.

8-CNVE: perfluoro(8-cyano-5-methyl-3,6-dioxa-1-octene), can be prepared by the process disclosed in U.S. Pat. No. 5,637,748.

Curing agent (CA-1): Dicyandiamide available from Sigma aldrich.

Carbon Black 1 (CB-1): Thermax® N908 medium thermal carbon black, STSA is 6-9, available from Cancarb Limited, Alberta, Canada.

Carbon Black 2 (CB-2): Neat90, available from CarbonNeat 16930 West Catawba Ave., Suite 102, Cornelius, NC 28031, STSA: 28-30

The materials shown in Table 1 were used to prepare Example 1 (E1), Example 2 (E2) and Comparative Example 1 (CEl) by compounding the ingredients on a two-roll rubber mill. The milled compounds were formed into sheets and samples were die cut into O-ring(s) (AS214) or Dogbone shape(s) to form the test specimens. Elogation at break and tensile strength were measured according to ASTM D1414.

TABLE 1

| | | E1 | E2 | CE1 |
|---|---|---|---|---|
| Formulation, phr | FE | 100 | 100 | 100 |
| | CA-1 | 0.39 | 0.39 | 0.39 |
| | CB-1 | — | — | 30 |
| | CB-2 | 30 | 20 | — |
| Physical | | | | |
| properties | | | | |
| O-ring | Elogation at | 160.8 | 264.23 | 162.08 |
| | Break (%) | | | |
| | Modulus at | 4.26 | 2.00 | 1.95 |
| | 50% (Mpa) | | | |
| Dogbone | Elogation at | 155.28 | 234.9 | 160.69 |
| | Break (%) | | | |
| | Modulus at | 5.34 | 2.65 | 2.54 |
| | 50% (Mpa) | | | |

What is claimed is:

1. A compound comprising:
(A) a fluoroelastomer comprising copolymerized units of:
(1) one or more unsaturated fluorinated olefins;
(2) one or more unsaturated fluorinated olefin co-monomer, which is different from (1), and selected from the group consisting of fluorovinyl ethers, unsaturated fluorinated olefins, unsaturated olefins, and mixtures of these; and
(3) one or more cure site monomers selected from the group consisting of nitrile-containing fluorinated olefins and nitrile-containing fluorinated vinyl ethers;
(B) at least one curing agent; and
(C) one or more carbon black, at least one carbon black has between 20 and 40 m²/g of statistical thickness surface area.

2. The compound of claim 1, wherein the curing agent comprises a compound that decompose at temperature between 40 °C and 330 °C to produce ammonia.

3. The compound of claim 1, wherein the curing agent comprises a compound which generate nitrogen-containing heterocycle cross links.

4. The compound any one of claims 1 to 3, wherein the carbon black has at least 60 g/kg of iodide absorption.

5. The compound any one of claims 1 to 4, wherein the carbon black comprises two or more kinds of carbon black.

6. The compound any one of claims 1 to 5, wherein the unsaturated fluorinated olefin is selected from the group consisting of tetrafluoroethylene, hexafluoropropylene, and mixtures of these.

7. The compound any one of claims 1 to 6, wherein the unsaturated fluorinated olefin co-monomer is selected from the group consisting of perfluoro(methyl vinyl) ether, hexafluoropropylene, perfluoro(propyl vinyl) ether, and mixtures of these.

8. The compound any one of claims 1 to 7, wherein the curing agent is selected from the group consisting of amidinoamidine HCl, N′, N″-diaminoamidine; phenyloxoaminoamidine, 3-(5-phenyl-4H-1,2,4-triazolyl)amidine, 1H-pyrrolylamidine, benzimidazolylamidine, aminothioxoamidine; gyanylthiourea, dicyandiamide, aminocarbonylmethylamidine HCl, N-aminoamidine bicarbonate, N″-1H-pyrazolyl-N′-t-butoxycarbonylamidine, 2-pyridylamidine HCl, sulfinoamidine, and mixtures of these.

9. The compound any one of claims 1 to 8, further comprising at least one filler selected from the group comprising nonperfluoro-fluorine-containing elastomers, micropowders, stabilizers, plasticizers, lubricants, processing aids, and mixtures of these.

10. An article, comprising a cured compound that, before curing, comprised:
(A) a fluoroelastomer comprising copolymerized units of:
(1) one or more unsaturated fluorinated olefins,
(2) one or more unsaturated fluorinated olefin co-monomer, which is different from (1), and selected from the group consisting of fluorovinyl ethers, unsaturated fluorinated olefins, unsaturated olefins, and mixtures of these; and
(3) one or more cure site monomers selected from the group consisting of nitrile-containing fluorinated olefins and nitrile-containing fluorinated vinyl ethers;
(B) at least one curing agent; and
(C) one or more carbon blacks, at least one carbon black has between 20 and 40 m²/g of statistical thickness surface area.

11. The article of claim 10, in the form of a gasket, tube, seal, and O-ring.
